(19) United States
(12) Patent Application Publication
(10) Pub. No.: US 2011/0151208 A1
(43) Pub. Date: Jun. 23, 2011

(54) METHOD FOR FABRICATING DECORATIVE FILM AND DECORATED ARTICLE FORMED WITH THE SAME THEREOF

(76) Inventors: MING-HUNG HUANG, Kaohsiung City (TW); TING-CHU HSU, Taoyuan County (TW); CHIH-YUAN LIAO, Hsinchu County (TW)

(21) Appl. No.: 12/728,868

(22) Filed: Mar. 22, 2010

(30) Foreign Application Priority Data
Dec. 20, 2009 (TW) 098145740

(51) Int. Cl. B44C 1/24; B32B 3/10

(52) U.S. Cl. 428/201; 156/219; 156/209

(57) ABSTRACT

The present invention discloses a method for fabricating a decorative film. In the method of the present invention, an embossing force is applied to a pressed surface of a semi-hardened releasing layer to form a patterned structure. After the releasing layer is solidified, a protective layer covers the releasing layer to form a transfer-printed structure thereon mating with the patterned structure. A stripping force is applied to the releasing layer to separate the releasing layer from the protective layer and expose the transfer-printed structure of the protective layer. Then, the user has a 3D tactile feeling when touching the surface of the protective layer.

### FIELD OF THE INVENTION

The present invention relates to a method for fabricating a decorative film, particularly to a method for fabricating a decorative film with a protective layer providing a touch feeling.

### BACKGROUND OF THE INVENTION

Owing to compactness and miniaturization, portable electronic products, such as notebook computers, personal digital assistants and mobile phones, have been indispensable apparatuses carried by people. Beside the physical functions, the appearance design of a product is also an important factor determining whether a customer buys it.

Traditionally, drawing or decorating on the plastic casing of a product is usually conducted via printing or spray-coating various patterns and colors on the casing. During a spray-coating process, various shielding coatings or shielding plates must be formed on the working region, and various types of paint are sprayed sequentially, which is a complicated and time-consuming process and unfavorable to mass production. A conventional spray-coating process usually generates a great amount of mist containing lead or other heavy metal, which not only wastes paint but also pollutes the environment. Besides, the hard coating or anti-abrasion coating is uneasy to have a uniform thickness because of different coating amount on different working regions, especially on a curved surface, coating accumulation usually occurs.

To solve the abovementioned problems, the related manufacturer developed an IMD (In Mold Decoration) technology. IMD includes an IMR (In Mold Roller) process. Firstly, a decorative film containing a hard layer is placed in an injection mold. Next, hot melt resin (or hot melt adhesive) is injected from one side of the film with an injection-molding method. Next, the hot melt resin and the decorative film are boned together to form a plastic article. Next, a support film having a releasing effect is stripped off from the plastic article to reveal the hard layer. Thus is completed the IMR process. The revealed outmost hard layer is usually a smooth surface having appropriate luster.

The modern marketing has a tendency to provide diversified products, and some customers have a favor of electronic products having a patterned and veined surface. Some IMD-related prior arts usually adopt a mold having a veined pattern to fabricate a surface providing a veiny touch, such as Japan patent Nos. 9-267357, 2001-179922, 2003-231150, and 2005-36168. However, such a mold is very expensive. Further, one mold can only generate a single pattern. If one intends to make different patterns, he has to make additional molds. Thus is increased the fabrication cost.

### SUMMARY OF THE INVENTION

In one embodiment, the present invention proposes a method for fabricating a decorative film, which comprises steps of:
(a) providing a semi-hardened releasing layer having a pressed surface;
(b) applying an embossing force to the pressed surface of the releasing layer to form a patterned structure on a region where the embossing force is applied;
(c) solidifying the semi-hardened releasing layer to set the patterned structure on the pressed surface; and
(d) covering the solidified releasing layer with a protective layer to form on the protective layer a transfer-printed structure mating with the patterned structure.
   wherein a roller-embossing process or a plate-embossing process applies an embossing force to the pressed surface to form the patterned structure.

In another embodiment, the releasing layer is located on a support layer.

In yet another embodiment, the protective layer is made of a radiation-cured material selected from a group consisting of multi-functional-group acrylic ester, epoxide, vinyl ester resins, diallyo(o—)phthalate, and vinyl ether.

In still another embodiment, the method of the present invention further comprises a step: applying a stripping force to the releasing layer to separate the releasing layer from the protective layer.

In a further embodiment, the method of the present invention further comprises a step: after the cured releasing layer is covered with the protective layer, forming a patterned layer on one side of the protective layer corresponding to the transfer-printed structure, wherein the patterned layer is formed with a screen-printing method or an intaglio method.

In a yet further embodiment, the method of the present invention further comprises a step: after the patterned layer is formed, an adhesion layer is formed on one side of the patterned layer connecting to the protective layer.

In a still further embodiment, the method of the present invention further comprises a step: after the adhesion layer is formed, applying a plastic material to one side of the adhesion layer connecting to the patterned layer. After the plastic material is hardened, a plastic article is formed tightly adhering to the adhesion layer.

### BRIEF DESCRIPTION OF THE DRAWINGS

FIG. 1 is a flowchart of a method for fabricating a decorative film according to a preferred embodiment of the present invention; and

FIGS. 2A-2G are diagrams schematically showing steps of a method for fabricating a decorative film according to a preferred embodiment of the present invention.

### DETAILED DESCRIPTION OF THE PREFERRED EMBODIMENTS

The present invention provides a method for fabricating a decorative film and a decorated article formed with the same thereof. Below, the embodiments are described in detail in cooperation with the drawings.

In the specification and drawings of the present invention, like reference numerals designate like elements. For clarity and convenience of description, some elements are not drawn according to the exact proportion. The elements and the assembly thereof are described below. However, the present invention does not limit the elements to be those depicted in the specification or drawings but also includes all forms of the elements obvious to the persons skilled in the art. In the specification, when a first material layer is referred to being formed or arranged “on” a second material layer or a substrate, it may be the case that the first material layer is directly arranged on the second material layer, or the case that the first material layer is indirectly arranged above the second material layer with a third material layer interposed between the first material layer and the second material layer.

Below, the technical contents of the present invention are described in accompany with the drawings.

The present invention applies to various IMD processes, including the IMR process, the IML (In Mold Label) process and the IMF (In Mold Forming) process, particularly to the IMR process.

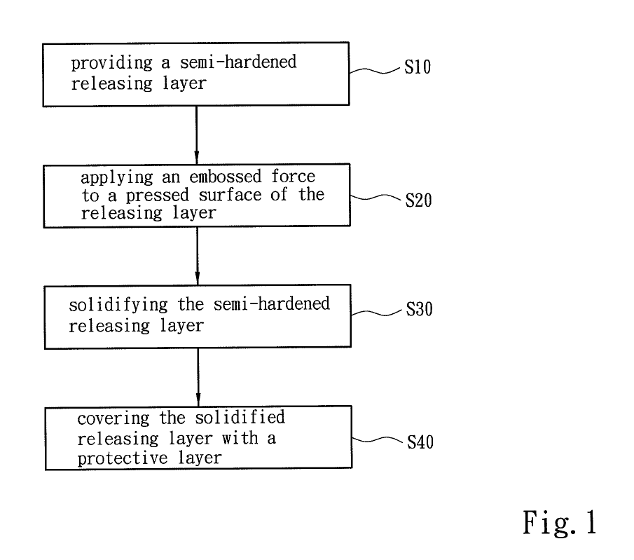

Refer to FIG. 1 a flowchart of a method for fabricating a decorative film according to a preferred embodiment of the present invention. In this embodiment, the method of the present invention comprises the steps of:
a step of providing a semi-hardened releasing layer (Step S10): providing a semi-hardened releasing layer having a pressed surface;
a step of applying an embossing force to the pressed surface of the releasing layer (Step S20): applying an embossing force to the pressed surface of the releasing layer to form a patterned structure on a region where the embossing force is applied;
a step of solidifying the semi-hardened releasing layer (Step S30): solidifying the semi-hardened releasing layer to set the patterned structure on the pressed; and
a step of covering the solidified releasing layer with a protective layer (Step S40): covering the solidified releasing layer with a protective layer to form a transfer-printed structure located on the protective layer mating with the patterned structure.

The details of the method of the present invention are described below.

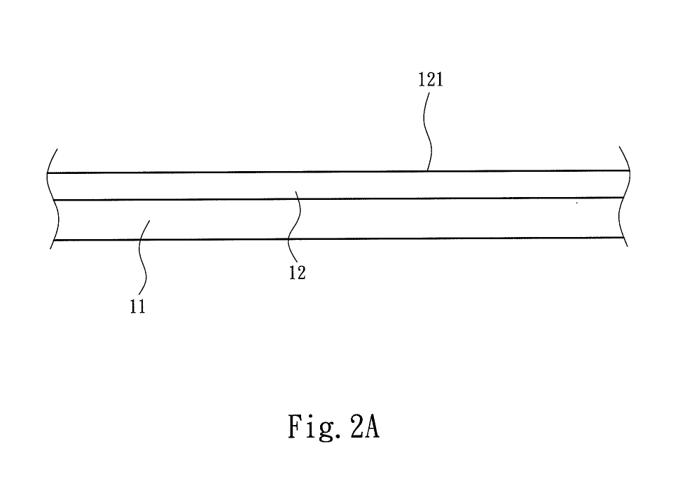

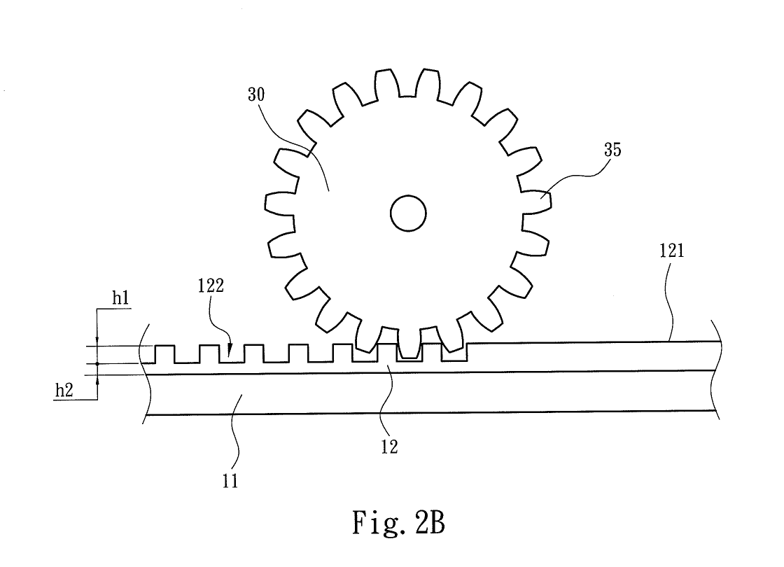

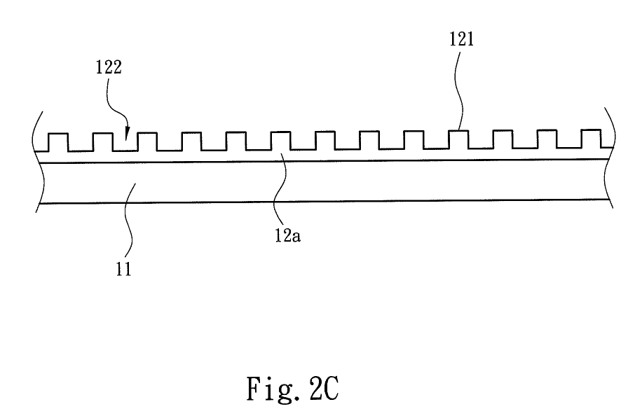

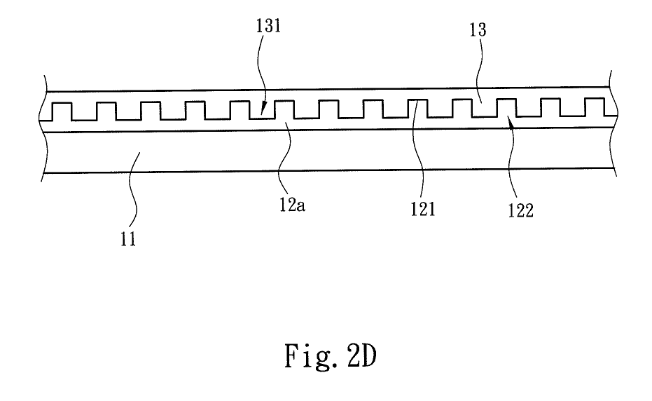

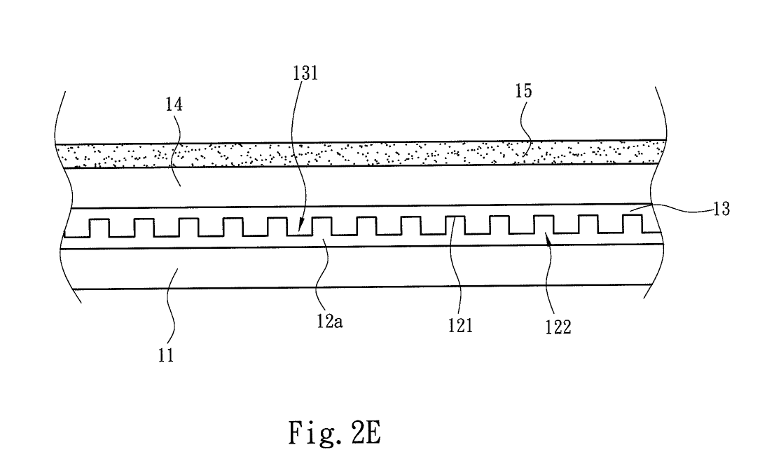

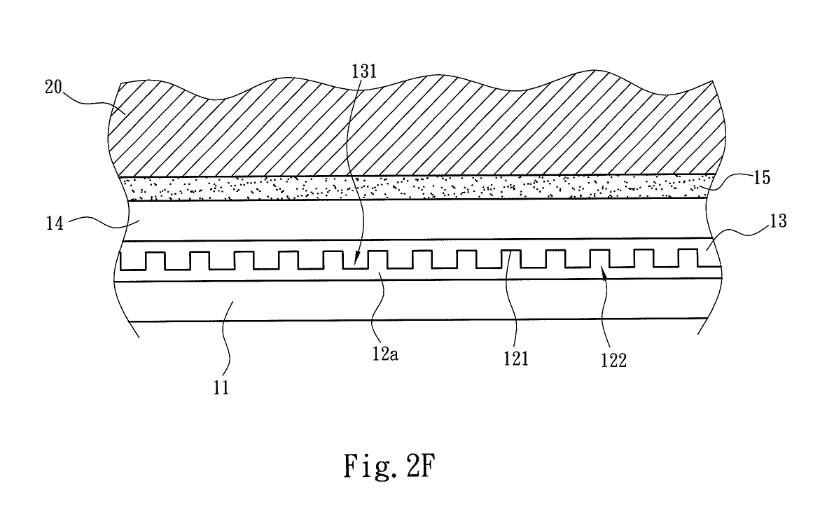

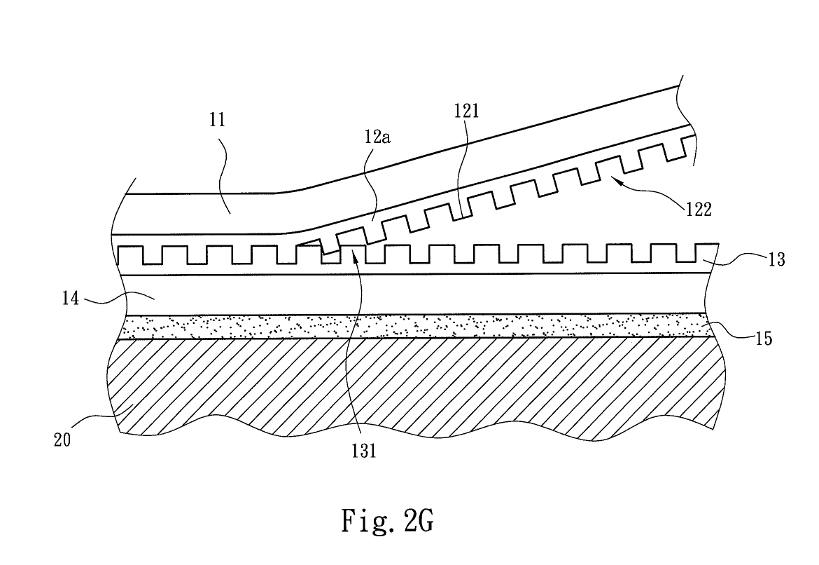

Refer to FIG. 2A. A semi-hardened releasing layer 12 is coated on a support layer 11, and the releasing layer 12 has a pressed surface 121. The material of the support layer 11 may be but is not limited to the polymeric material selected from a group consisting of PET (polyethylene terephthalate), PEN (polyethylene naphthalate), PETG (polyethylene glycol-co-cyclohexane-1,4 dimethanol terephthalate), TPU (thermalplastic polyurethane), PU (polyurethane), PP (polypropylene), PC (polycarbonate), A-PET (amorphous polyethylene terephthalate), PVC (polyvinyl chloride), TAC (triacetyl cellulose), PMMA (polymethylmethacrylate), MS (MMA-St), COC (cyclo olefin copolymer), and a combination of the abovementioned polymeric materials.

Refer to FIG. 2B. After the semi-hardened releasing layer 12 has been coated on the support layer 11, a roller 30 having a microstructure pattern 35 applies an embossing force to the pressed surface 121 of the releasing layer 12 to transfer-print the microstructure pattern 35 on the pressed surface 121 of the releasing layer 12 and form a patterned structure 122 on the region where the embossing force is applied. In one embodiment, a plate-embossing process provides the embossing force. The patterned structure 122 on the pressed surface 121 has a depth h1 of at least 10 μm. In another embodiment, the patterned structure 122 has a depth h1 between 10 and 40 μm. Besides, the releasing layer 12 has a thickness h2 of at least 1 μm. In other words, the releasing layer 12 is continuously coated on the support layer 11. And after the patterned structure 122 is formed, the semi-hardened releasing layer 12 is solidified to set the patterned structure 122 on the pressed surface 121. Refer to FIG. 2C. The semi-hardened releasing layer 12 can be solidified by radiation or heat to form a solidified releasing layer 12a.

Refer to FIG. 2D. The solidified releasing layer 12a is covered with a protective layer 13. The material of the protective layer 13 may be but is not limited to the radiation-cured material selected from a group consisting of multi-functional-group acrylic ester, epoxide, vinyl ester resins, diallyo(o—)phthalate, vinyl ether, and a combination of the abovementioned materials. The radiation-cured multi-functional-group acrylic ester may be EA (epoxy acrylate), PUA (polyurethane acrylate), PA (polyester acrylate), SA (silicone acrylate), or GA (glycidyl acrylate). As the protective layer 13 is made of a plastic resin, the protective layer 13 can conform to the shape of the surface covered by it to form a corresponding structure. Therefore, a transfer-printed structure 131 corresponding to the patterned structure 122 of the releasing layer 12a is formed on the protective layer 13.

Refer to FIG. 2E. After the solidified releasing layer 12a has been covered with the protective layer 13, a patterned layer 14 and an adhesion layer 15 are formed at one side of the protective layer 13, which is opposite to the transfer-printed structure 131, to enrich the colors and patterns of the decorative film. The patterned layer 14 is formed on the protective layer 13 with a screen-printing method or an intaglio method. The patterned layer 14 is made of a sublime transfer-printing ink, a hot melt transfer-printing ink, or a UV transfer-printing ink. The adhesion layer 15 is made of a hot melt adhesive, a UV adhesive, a light-activated adhesive, or an e-beam-activated adhesive. The patterned layer 14 is formed on a region exactly or not exactly corresponding to the region of the transfer-printed structure 131.

Refer to FIG. 2F. After the patterned layer 14 and the adhesion layer 15 have been formed, a plastic material is formed at one side of the adhesion layer 15, which is connected to the patterned layer 14, and then a plastic article 20 is formed and tightly adhered to the adhesion layer 15 after the plastic material is solidified. The plastic material is formed on the adhesion layer 15 with an injection-forming method, a hot-pressing method, a compression-forming method, a spray-forming method, or an extrusion-forming method. In other words, the decorative film, which contains the support layer 11, releasing layer 12a, protective layer 13, patterned layer 14 and adhesion layer 15, is attached to the plastic article 20 formed by the solidified plastic material. The plastic material may be but is not limited to the material selected from a group consisting of PC (polycarbonate), PP (polypropylene), PMMA (polymethylmethacrylate), MS (MMA-St), ABS (acrylonitrile butadiene styrene), PS (polystyrene), PET (polyethylene terephthalate), and POM (polyoxymethylene).

Refer to FIG. 2G. After the decorative film has been tightly attached to the plastic article 20, a stripping force is applied to the releasing layer 12a and the support layer 11 to separate the releasing layer 12a and the support layer 11 from the protective layer 13. Thus, the protective layer 13 is exposed at the outmost layer, and the user can touch the transfer-printed structure 131 of the protective layer 13.

The decorative film fabricated according to the method of the present invention is integrated with the plastic article 20 to form various decorated articles. The decorated articles may be but is not limited to the casings of the following products: mobile phones, digital cameras, PDAs, notebook computers, desktop computers, touchpanels, televisions, GPS, vehicle displays, aviation displays, digital photo frames, portable DVD players, cosmetics, toys, vehicle instrument panels, clocks, radio receivers, watches, credit cards, and smart cards.

In conclusion, the present invention proposes a method for fabricating a decorative film, wherein an embossing force is applied to a releasing layer to form a patterned structure, and after the releasing layer is solidified, a protective layer covers the patterned structure of the releasing layer to form a transfer-printed structure on the protective layer mating with the patterned structure. The transfer-printed structure is formed of a plurality of 3D bulges and recessions and provides users with a tactile feeling distinct from that provided by the conventional smooth surface. In other words, the decorative film fabricated according to the method of the present invention provides an article with bulges and recessions and gives users a 3D touch. Further, the transfer-printed structure may be designed to simulate the veins of the patterns to provide a special aesthetic effect.

In comparison with the conventional IMR process that uses different molds to make different transfer-printed structures, the present invention can make different transfer-printed structures via merely changing the embossed regions of the releasing layer, namely changing the rollers or plates. Therefore, the present invention can greatly reduce the fabrication cost. The present invention has improvements over the conventional technologies and meets the condition for a patent. Thus, the Inventor files the application. It will be appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. A method for fabricating a decorative film, comprising steps of:
providing a semi-hardened releasing layer having a pressed surface;
applying an embossing force to the pressed surface of the releasing layer to form a patterned structure on a region where the embossing force is applied;
solidifying the semi-hardened releasing layer to set the patterned structure on the pressed surface; and
covering the solidified releasing layer with a protective layer to form a transfer-printed structure thereon mating with the patterned structure.

2. The method for fabricating a decorative film according to claim 1, wherein a roller-embossing process applies the embossing force to the pressed surface to form the patterned structure.

3. The method for fabricating a decorative film according to claim 1, wherein a plate-embossing process applies the embossing force to the pressed surface to form the patterned structure.

4. The method for fabricating a decorative film according to claim 1, wherein the releasing layer is arranged on a support layer.

5. The method for fabricating a decorative film according to claim 1, wherein the patterned structure has a depth of at least 10 μm.

6. The method for fabricating a decorative film according to claim 1, wherein in the step of solidifying the semi-hardened releasing layer, the releasing layer is solidified with radiation or heat.

7. The method for fabricating a decorative film according to claim 1, wherein the protective layer is made of a radiation-cured material selected from a group consisting of multi-functional-group acrylic ester, epoxide, vinyl ester resins, diallyo(o—)phthalate, vinyl ether, and a combination of the abovementioned materials.

8. The method for fabricating a decorative film according to claim 1 further comprising a step: after the protective layer has covered the solidified releasing layer, forming a patterned layer on one side of the protective layer, which is opposite to the transfer-printed structure.

9. The method for fabricating a decorative film according to claim 8, wherein the patterned layer is formed on the protective layer with a screen-printing method or an intaglio method.

10. The method for fabricating a decorative film according to claim 8, wherein the patterned layer is formed on a region corresponding to the region of the transfer-printed structure.

11. The method for fabricating a decorative film according to claim 8 further comprising a step: after the patterned layer has been formed, forming an adhesion layer on one side of the patterned layer, which is connected to the protective layer.

12. The method for fabricating a decorative film according to claim 11 further comprising a step: after the adhesion layer has been formed, disposing a plastic material on one side of the adhesion layer, which is connected to the patterned layer, wherein the plastic material is hardened to form a plastic article tightly adhered to the adhesion layer.

13. The method for fabricating a decorative film according to claim 12, wherein the plastic material is selected from a group consisting of PC (polycarbonate), PP (polypropylene), PMMA (polymethylmethacrylate), MS (MMA-St), ABS (acrylonitrile butadiene styrene), PS (polystyrene), PET (polyethylene terephthalate), and POM (polyoxymethylene).

14. The method for fabricating a decorative film according to claim 1 further comprising a step: applying a stripping force to the releasing layer to separate the releasing layer from the protective layer.

15. A decorated article comprising
a decorative film fabricated according to claim 1; and
a plastic article supporting the decorative film.

16. The decorated article according to claim 15, which is a casing of a mobile phone, a digital camera, PDA, a notebook computer, a desktop computer, a touchpanel, a television, GPS, a vehicle display, an aviation display, a digital photo frame, a portable DVD player, a cosmetic, a toy, a vehicle instrument panel, a clock, a radio receiver, a watch, a credit card, or a smart card.
